(19) United States
(12) Patent Application Publication
(10) Pub. No.: US 2012/0008166 A1
(43) Pub. Date: Jan. 12, 2012

(54) DISPLAY CONTROL APPARATUS AND DISPLAY CONTROL METHOD

(75) Inventors: Keiichi Noto, Shiojiri-shi (JP); Toru Matsuyama, Matsumoto-shi (JP)

(73) Assignee: Seiko Epson Corporation, Tokyo (JP)

(21) Appl. No.: 13/177,819

(22) Filed: Jul. 7, 2011

(30) Foreign Application Priority Data
Jul. 7, 2010 (JP) 2010-154533

(51) Int. Cl. G06K 15/02

(52) U.S. Cl. 358/1.15

(57) ABSTRACT

The display control apparatus includes an acquisition section configured acquire a piece of characteristic information representing an output characteristic specific to a corresponding printing apparatus from each of a plurality of printing apparatuses; and a display section configured to determine an order for arraying the plurality of printing apparatuses on the basis of the pieces of characteristic information having been acquired, each being specific to a corresponding printing apparatus, and array and display the plurality of printing apparatuses on a predetermined image display screen in the order having been determined.

### BACKGROUND

1. Technical Field

The present invention relates to a display control apparatus and a display control method.

2. Related Art

To date, distributed printing systems, each including a computer functioning as a host and a plurality of printers connected thereto via a network, and allowing the host to transmit print data to the plurality of printers and cause the plurality of printers to execute printing on the basis of the print data, have been known.

With respect to technologies for such a distributed printing system, an information processing apparatus, which is provided with technologies for separating a print job into separated print jobs, and causing a plurality of printing apparatuses to each execute printing processing on a corresponding separated print job, has been known (refer to JP-A-2006-195531). The technologies provided therein are such that, in the case where a user has requested processing that is given priority on image quality, by determining printing apparatuses, each having print resolution higher than a predetermined value, as destinations of the respective separated jobs from among a plurality of printing apparatuses having been registered, occurrence of variations in the image quality among output results due to variations in the print resolution is prevented; while, in the case where a user has requested processing that is given priority on an apparatus type, by determining printing apparatuses of the same manufacturer as destinations of the respective separated print jobs from among a plurality of printing apparatuses having been registered, occurrence of differences in color tone among output results, which are likely to occur among different types of printing apparatuses, is prevented.

With respect to printers, it is ideal that each printer has output characteristics consistent with a design criterion, but, in reality, each printer has output characteristics specific thereto. Specifically, an amount for each drop of ink discharged by each of printers is likely to be slightly different among the printers. Such variations in any ones of the output characteristics also exist among printers, such as shown in JP-A-2006-195531, each having print resolution within a predetermined range, or being of the same apparatus type (of the same manufacturer). Therefore, even if, in JP-A-2006-195531, a user is allowed to select processing that is given priority on image quality or processing that is given priority on an apparatus type, it is impossible to prevent occurrence of variations among results of printing performed by the respective printing apparatuses due to such variations in the output characteristic. Furthermore, under an environment where a plurality of printers having respective output characteristics that vary from one another exist, differences in printing results occur depending on selection of printers to be used for printing. Accordingly, it has been important to provide an environment that enables users to appropriately select printers each bringing their desired printing result.

### SUMMARY

An advantage of some aspects of the invention is to provide a display control apparatus and a display control method that make it possible, under an environment where a plurality of printers can be used, easily and appropriately select printers to be used for printing.

A display control apparatus according to an aspect of the invention includes an acquisition section configured to acquire a piece of characteristic information representing an output characteristic specific to a corresponding printing apparatus from each of a plurality of printing apparatuses; and a display section configured to determine an order for arraying the plurality of printing apparatuses on the basis of the pieces of characteristic information having been acquired, each being specific to a corresponding printing apparatus, and array and display the plurality of printing apparatuses on a predetermined image display screen in the order having been determined.

According to the aspect of the invention, a plurality of printing apparatuses are arrayed and displayed on an image display screen in the order having been determined on the basis of the above-described pieces characteristic information, and thus, it is possible for users to, when selecting printing apparatuses from among the plurality of printing apparatuses, easily and appropriately select their desired printing apparatuses by taking into account priorities of the respective printing apparatuses.

The above-described display section may be configured to array and display the plurality of printing apparatuses in an order starting from a printing apparatus having the largest amount of color-material output. This configuration enables provision of an environment that enables users to easily select printing apparatuses each having a tendency towards a large amount of color-material output.

Alternatively, the above-described display section may be configured to array and display the plurality of printing apparatuses in an order starting from a printing apparatus having the smallest amount of color-material output. This configuration enables provision of an environment that enables users to easily select printing apparatuses each having a tendency towards a small amount of color-material output.

Further, the above-described display section may be configured to, in accordance with a preset printing condition, perform switching of two modes, one being a mode for arraying and displaying the plurality of printing apparatuses in an order starting from a printing apparatus having the largest amount of color-material output, the other one being a mode for arraying and displaying the plurality of printing apparatuses in an order starting from a printing apparatus having the smallest amount of color-material output. The printing condition described above includes, for example, a kind of a printing medium used for printing, a kind of a color material used for printing, a printing mode, the content of an image targeted for printing, and the like. That is, it depends on such a printing condition which one of two environments is preferable for users, one being an environment that enables users to easily select printing apparatuses each having a tendency towards a large amount of color-material output, the other one being an environment that enables users to easily select printing apparatuses each having a tendency towards a small amount of color-material output. Accordingly, as described above, by performing switching of the two modes for arraying and displaying the printing apparatuses in accordance with the preset printing condition, it is possible to provide users who attempt to select printing apparatuses with an image display screen most appropriate to the users.

The display control apparatus according to the aspect may further include a grouping processing section configured to, by grouping certain ones of the plurality of printing apparatuses, which have respective pieces of characteristic information close to one another, into a group, partition the plurality of printing apparatuses into a plurality of groups, and the above-described display section may be configured to, when arraying and displaying the plurality of printing apparatuses, array and display the printing apparatuses by each of the groups. This configuration enables users to, when selecting a plurality of printing apparatuses in order to perform distributed printing or the like, easily select the plurality of printing apparatuses having respective characteristics similar to one another.

The above-described display section may be configured to, when arraying and displaying the plurality of printing apparatuses on an image display screen, display a cursor in addition thereto, which is movable on the image display screen in accordance with an operation from outside, and is used for selecting one or more printing apparatuses from among the plurality of printing apparatuses having been displayed on the image display screen, and allocate an initial position of the cursor at a location where the cursor can select any one of the printing apparatuses, which has the characteristic information most close to a reference value of the characteristic information, or the printing apparatus having the characteristic information most close thereto and partial ones of the printing apparatuses, each of the partial ones thereof having the characteristic information close to that of the printing apparatus having the characteristic information most close thereto. This configuration enables provision of an image display screen on which one or more printing apparatuses having respective optimum output characteristics (i.e., respective pieces of characteristic information close to a reference value) are selected by the cursor locating at an initial position thereof. Accordingly, it is possible for users to, upon view of the cursor, instantly recognize one or more printing apparatuses having respective optimum output characteristics, and make a selection determination.

The above-described display section may be configured to perform a warning indication when a plurality of the printing apparatuses having any difference more than or equal to a predetermined number among respective priorities thereof in accordance with the order thereof have been selected in accordance with an operation from outside from among the plurality of printing apparatuses having been displayed. According to this configuration, when a user has selected a plurality of printing apparatuses having respective output characteristics largely different from one another on the image display screen, the above-described warning indication is performed. Therefore, it is possible to prevent occurrence of variations in the output characteristic among printing results due to use of a plurality of printing apparatuses having any large difference among respective output characteristics thereof.

Technical thoughts according to the aspect of the invention can be also realized by methods other than the display control apparatus. For example, it is possible to realize a display control method including processes corresponding to the respective sections included in the above-described display control apparatus (i.e., processes of acquiring and displaying), as well as a program causing a computer to execute functions corresponding to the respective sections included in the above-described display control apparatus. Furthermore, the display control apparatus and the display control method may further include functions and processes, respectively, each performing control of printing apparatuses to cause the printing apparatuses to execute printing.

### BRIEF DESCRIPTION OF THE DRAWINGS

The invention will be described with reference to the accompanying drawings, wherein like numbers reference like elements.

FIG. 1 is a schematic diagram illustrating an apparatus configured to realize a display control method according to an aspect of the invention.

FIG. 2 is a flowchart illustrating processes including a UI image display process, according to an aspect of the invention.

FIG. 3 is a diagram illustrating an example of a UI image according to an aspect of the invention.

FIGS. 4A, 4B and 4C are diagrams each illustrating an example of a UI image according to an aspect of the invention.

FIG. 5 is a diagram illustrating an example of a UI image including a warning indication, according to an aspect of the invention.

### DESCRIPTION OF EXEMPLARY EMBODIMENTS

Hereinafter, embodiments according to the invention will be described with reference to drawings.

### 1. Outline of Configuration of this Embodiment

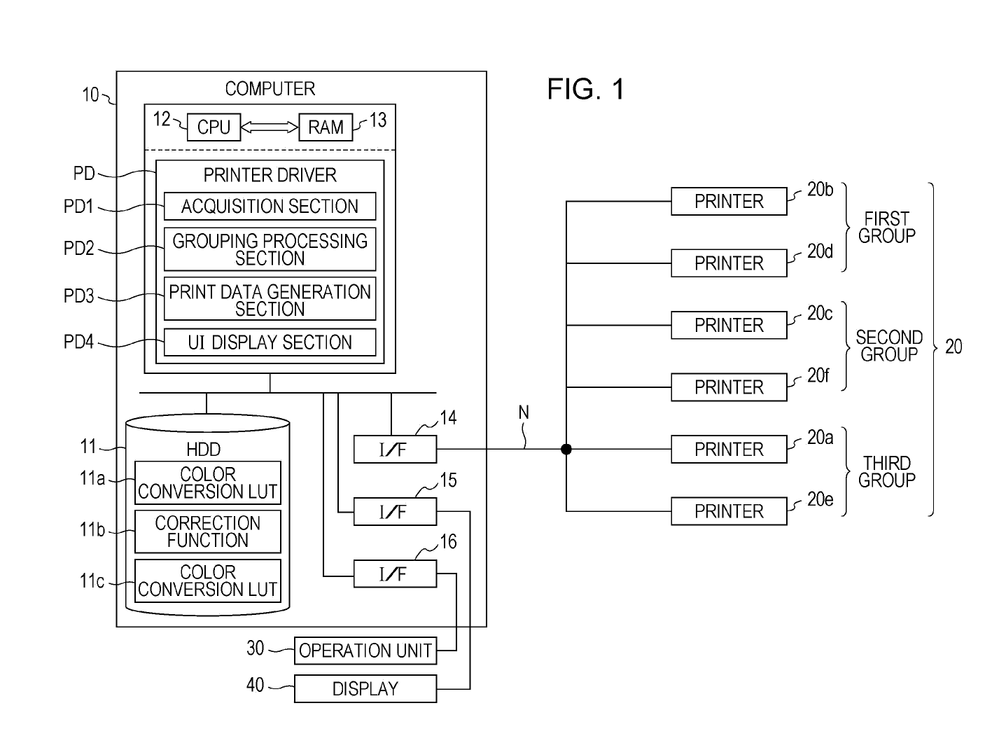

FIG. 1 is a schematic diagram illustrating an apparatus configured to realize a display control method according to this embodiment. Here, a plurality of printers 20 used for distributed printing and a computer 10 functioning as a host for the printers 20 are shown. Hereinafter, in the case where the plurality of printers 20 need to be identified one by one, they will be also denoted by a printer 20a, a printer 20b, a printer 20c, a printer 20d, a printer 20e, a printer 20f . . . . The computer 10 is connected to the printers 20 via a wired or wireless network N, and is capable of performing control of the printers 20 to cause the printers 20 to execute distributed printing. The distributed printing includes various modes, such as a mode for causing the plurality of printers 20 to print the same image, and a mode for allocating individual ones of a plurality of pages included in a file targeted for printing to each of the plurality of printers 20 to cause the printer 20 to print them.

Substantially, the display control method is realized by functions of the computer 10. A CPU 12 included in the computer 10 retrieves programs stored in a memory device, such as a hard disc drive (HDD) 11, deploys the programs on a RAM 13, and concurrently therewith, performs operations in accordance with the programs. The CPU 12 displays a predetermined user interface (UI) image 41 on an display 40, performs control of the printers 20 via a network interface (an I/F 14) and the network N, and the like by performing operations in accordance with the programs (for example, a printer driver PD) running on an OS. Therefore, the computer 10 can be recognized as a display control apparatus, and further, as a printing control apparatus. Furthermore, a system including the computer 10 and the printers 20 can be also recognized as a printing control apparatus. The computer 10 is connected to the display 40 via a video interface (an I/F 15), and is also connected to an operation unit 30, such as a keyboard and a mouse device, via an input interface (an I/F 16).

The printer driver PD realizes functions of an acquisition section PD1, a UI display section PD4, a grouping processing section PD2, a print data generation section PD3 and the like. The acquisition section PD1 is configured to acquire pieces of characteristic information representing output characteristics specific to the respective printers 20 from the plurality of printers 20. Further, the UI display section PD4 is configured to determine an order for arraying the plurality of printers 20 on the basis of the pieces of characteristic information corresponding to the respective printers 20, and array the plurality of printers 20 on an image display screen of the display 40 in the order having been determined. Further, the grouping processing section PD2 is configured to group the plurality of printers 20 into a plurality of groups on the basis of the pieces of characteristic information corresponding to the respective printers 20. Further, the print data generation section PD3 is configured to, when, in order to cause the printers 20 to print respective images targeted for printing, generating blocks of print data to be supplied to the corresponding printers 20, generate the blocks of print data on the basis of pieces of characteristic information associated with respective groups to which the corresponding printers 20 belong.

### 2. Processes Including UI Image Display Process

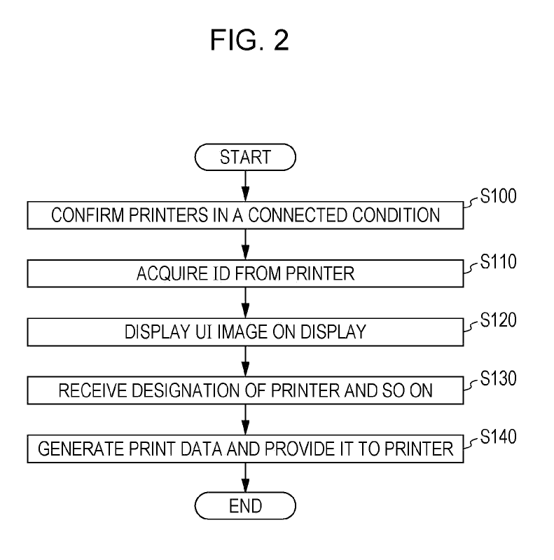

FIG. 2 is a flowchart illustrating processes the computer 10 performs in accordance with the printer driver PD.

In step S100, the computer 10 confirms the printers 20 each being currently connected to the network N in an available condition. That is, the computer 10 detects and recognizes all of the printers 20, which can be targets for control, on the network N. Here, it is assumed that the computer 10 has recognized the printers 20a, 20b, 20c, 20d, 20e and 20f.

In step S110, the computer 10 communicates with the individual printers 20 having been recognized in step S100 on the network N, and acquires weight-of-ink IDs retained by the respective printers 20. The ID is a kind of the above-described characteristic information. For example, if each of the printers 20 is an ink jet printer, the ID is a numerical value representing a variation in an amount of ink discharged by a print head included in the printer 20 (for example, a weight of ink for each drop of ink (i.e., each dot) discharged by a print head) relative to a reference value (i.e., a reference weight). Such an ID is obtained in advance when manufacturing a corresponding print head, and is recorded in a predetermined memory module included in the printer 2 incorporating the corresponding print head (or in a memory module incorporated in the corresponding print head).

The ID is, for example, any one of numerical values from “1” to “21”, and an ID corresponding to the reference weight is a central numerical value “11”. With respect to print heads each having a piece of characteristic information representing a weight of ink for each drop of ink discharged thereby, print heads each having a weight of ink therefor larger than the reference weight are given IDs, each representing a numerical value smaller than the central numerical value “11” and becoming further smaller in proportion to the largeness of the weight of ink; while print heads each having a weight of ink therefor smaller than the reference weight are given IDs, each representing a numerical value larger than the central numerical value “11” and becoming larger in proportion to the smallness of the weight of ink. The computer 10 transmits an acquisition request for acquiring an ID to each of the printers 20. Subsequently, upon receipt of the acquisition request, in response to the acquisition request, each of the printers 20 reads out an ID recorded in the printer 20 itself, and transmits the read-out ID to the computer 10. Consequently, the computer 10 acquires IDs of the respective printers 20. Here, for the sake of simplification of explanation, it is assumed that the computer 10 acquires one ID from one of the printers 20. With respect to such an ID, refer to JP-A-2007-55013 and/or JP-A-2009-149096 when necessary.

In addition, a piece of characteristic information for each printer, which is acquired by the computer 10 from each of the printers 20 in step S110, is not limited to the weight-of-ink ID, but, may be one of any conceivable variety of pieces of information capable of representing respective characteristics specific to each of the printers 20. For example, the printers 20 are each caused to print a predetermined color patch in advance. Further, printed color patches are subjected to respective color measurements using a color measurement tool. Further, a result of each of the color measurements (i.e., a color value) and a result of a color measurement of a printed color patch resulting from printing of the predetermined color patch having been performed by a design-basis printer (i.e., a reference color value) are compared to each other. Moreover, a numerical value representing a degree of difference resulting from the comparison of the color values (i.e., an ID) is generated for each of the printers 20, and the generated ID is recorded in a predetermined memory module in each of the printers 20. Further, in step S110, such an ID that is generated for each of the printers 20 on the basis of the result of the color measurement may be acquired as an output characteristic (i.e., a piece of characteristic information) specific to each of the printers 20. Meanwhile, the printers 20 are each provided with a paper transporting mechanism for transporting print paper in a predetermined direction relative to a print head, and an error in an amount of transport (an error relative to a design-basis transport amount) varies for each of the printers 20. Such an error in the amount of transportation is also one of elements affecting printing quality. Therefore, a degree of an error in the amount of transport may be converted into a numerical value (i.e., an ID) for each of the printers 20, and the ID may be recorded in a predetermined memory module included in each of the printers 20. Further, in step S110, an ID representing such a degree of an error in the amount of transportation may be acquired as an output characteristic (i.e., a piece of characteristic information) specific to each of the printers 20.

Hereinafter, description will be continued by providing a an example in which the weight-of-ink ID is treated as the ID.

In step S120, the computer 10 performs control of the display 40 via the I/F 15 by executing the function of the UI display section PD4 to cause the display 40 to display the UI image 41 on the display 40. In this case, the computer 10 determines an order of the printers 20 starting from the printer 20 having the largest amount of color-material output (i.e., the largest amount of weight of ink), that is, an order of the printers 20 starting from the printer 20 having the smallest ID, on the basis of the IDs having been acquired from the respective printers 20. Here, it is assumed that the computer 10 has determined an order such as “the printer 20e, the printer 20a, the printer 20b, the printer 20d, the printer 20c, the printer 20f” (the printer 20e has the largest amount of color-material output; while the printer 20f has the smallest amount of color-material output). Further, the computer 10 displays the UI image 41 including the names of the respective printers 20, which are arrayed and described in the order having been determined, on the display 40.

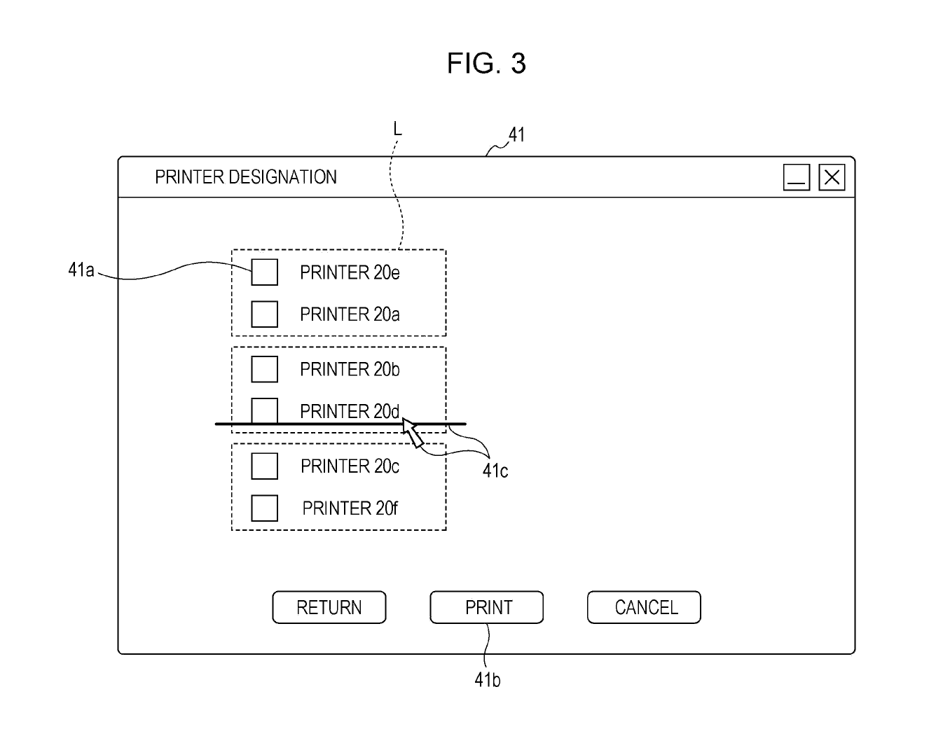

FIG. 3 is a diagram illustrating an example of the UI image 41. As shown in FIG. 3, in the UI image 41, the names of the respective printers 20 are arrayed and displayed in such an order that the printer 20e is located at a top position thereof, and below it, the printers 20a, 20b, 20d, 20c and 20f are each located in series. That is, a plurality of names of the respective printers 20 are arrayed and displayed in a direction from top to bottom of the image display screen in an order starting from the printer 20 having the largest amount of color-material output. The computer 10 may determine an order thereof reversing that of the example shown in FIG. 3, which starts from the printer 20 having the smallest amount of color-material output (i.e., an order thereof starting from the printer 20 having the largest ID), that is, an order such as “the printer 20f, the printer 20c, the printer 20d, the printer 20b, the printer 20a, the printer 20e”, on the basis of the IDs having been acquired from the respective printers 20.

In the UI image 41, checkboxes 41a are displayed adjacent to the respective names of the printers 20. Upon view of the UI image 41, a user can designate (select) any ones of the printers 20 the user desires as those to be used for printing by operating the operation unit 30 onto the checkboxes 41a corresponding to the printers 20 the user desires. It is possible to designate one or a plurality of the printers 20. Further, a print button 41b is displayed in the UI image 41. After having designated the printers 20 in such a manner as described above, the user can instruct the computer 10 to cause the designated printers 20 to execute printing processing by operating the operating unit 30 onto the print button 41b.

Moreover, the computer 10 may partition the plurality of printers 20 into groups by grouping the printers 20 having respective pieces of characteristic information closely similar to one another into each of the groups, and may display the individual printers 20 in the UI image 41 in such a display method that enables identification of each of the groups, such as a display method using chain lines L shown in FIG. 3.

During processing for acquiring IDs from the respective printers 20 and displaying the UI image 41 on the display 40, the computer 10 compares the IDs having been acquired from the respective printers 20 with a reference ID, and thereby, partitions the individual printers 20 into a plurality of groups by executing the function of the grouping processing section PD2. The reference ID is an ID that is retained by a design-basis printer, and corresponds to the central numerical value “11” indicating the above-described reference weight. In this embodiment, the computer 10 has the reference ID in advance.

There are a variety of specific methods for partitioning the printers 20 into groups, and in this embodiment, as an example thereof, the computer 10 employs a method for partitioning the plurality of printers 20 into three groups, a first group including the printers 20 each having an ID that is different from a reference ID by a value less than a predetermined value (for example, “5”), a second group including the printers 20 each having an ID that is different from the reference ID by a value more than or equal to the predetermined value “5”, and further, is larger than the reference ID, a third group including the printers 20 each having an ID that is different from a reference ID by a value more than or equal to the predetermined value “5”, and further, is smaller than the reference ID. FIGS. 1 and 3 each show a condition resulting from the partition, in which the printers 20b and 20d belong to the first group, the printers 20c and 20f belong to the second group, and the printers 20e and 20a belong to the third group. Obviously, with respect to display methods for displaying the plurality of printers 20 having been partitioned into groups in the UI image 41, it is possible to employ various methods (designs) other than the method, such as shown in FIG. 3, in which each group is surrounded with a line, and, for example, another method, in which indication colors for respective groups are different from one another, may be employed.

Moreover, the computer 10 displays a cursor 41c, which is movable on the image display screen in accordance with operations of the operation unit 30 performed by a user, by executing the function of the UI display section PD4. The cursor 41c is configured by an indication, such as an arrow or an underline, appended around a name of the printer 20 being temporarily selected in the UI image 41, and moves to/from the names of a plurality of the printers 20 listed in the UI image 41 in conjunction with movements of a mouse device or the like, performed by a user. In this embodiment, it is assumed that, when displaying the UI image 41, the computer 10 sets a position of the cursor 41c in a condition in which any operations are not performed by users (i.e., an initial position of the cursor 41c) to a location where the cursor 41c can select the printer 20 having a piece of characteristic information most close to a reference value of the characteristic information (i.e., a reference ID), or the printer 20 having a piece of characteristic information most close thereto and partial ones of the printers 20 each having a piece of characteristic information close to that of the printer 20 having a piece of characteristic information most close thereto.

FIG. 3 shows an example of a condition where the cursor 41c is located at an initial position thereof. Here, an example, in which the printer 20 having an ID most close to a reference ID is the printer 20d, is shown, and thus, the initial position of the cursor 41c is located at a position pointing the printer 20d. Alternatively, as described above, in the case where a plurality of the printers 20 having been partitioned into groups are displayed in the UI image 41, the computer 10 may allocate the initial position of the cursor 41c at a location pointing the whole of a group, to which the printer 20 having an ID most close to a reference ID (i.e., the printer 20d) belongs (i.e., the first group). That is, the computer 10 may display the cursor 4c in such a display method that enables visual perception of a condition in which the whole of the first group is currently selected.

In step S130, under the condition where the computer 10 causes the UI image 41 to be displayed on the display 40, the computer 10 receives designations of one or more ones of the printers 20 (i.e., inputs to the checkboxes 41) and a print instruction (pushing down of the print button 41b) via the operation unit 30 and the I/F 16. In addition, it is assumed that, prior to receipt of pushing down of the print button 41b in the UI image 41, the computer 10 receives selection of an image targeted for printing and setting of other kinds of printing conditions via other UI images.

In step S140, the computer 10 generates print data in accordance with the print instruction issued by a user by executing the function of the print data generating section PD3, and supplies the generated print data to the printers 20 via the I/F 14 and the network N. In this case, firstly, the computer 10 calculates an average value for each of groups resulting from excluding the first group from groups to which the above-described designated printers 20 belong. For example, if the printer 20c is designated, the computer 10 calculates an average value of IDs of the respective printers 20c and 20f belonging to the second group, and treats the calculated average value as an ID for the second group. Next, by correcting a color conversion lookup table (a color conversion LUT) on the basis of the above-described average value of IDs, which has been generated for each of the groups, the computer 10 generates a corrected color conversion LUT 11a′ corresponding to each of the groups resulting from excluding the first group from groups to which the above-described designated printers 20 belong. The color conversion LUT 11a is a reference table for converting the above-described selected image targeted for printing (for example, the selected image including pixels, each being represented by a color representation system consisting of red (R), green (G) and blue (B)) into data represented by a color representation system (for example, a color representation system consisting of cyan (C), magenta (M), yellow (Y), black (B), light cyan (Lc) and light magenta (Lm)) for a color material (ink or toner) used by each of the printers 20, and causes gray-scale values for each color at the input side, each being represented by the color representation system (RGB), to correspond to gray-scale values for each color at the output side, each being represented by the color representation system (CMYKLcLm). The color conversion LUT 11a is generated on the assumption that each of the printers 20 for executing printing is a design-basis printer, and is stored in the HDD 11 in advance.

The computer 10 causes the plurality of IDs and a plurality of correction functions 11b to correspond to each other, and stores them in the HDD 11 in advance. The correction functions 11b are functions for correcting the color conversion LUT 11a. Any one of the correction functions 11b is a function for determining a conversion relation between input gray-scale values and output gray-scale values, and the correction function 11b corresponding to the reference ID “11” is a function for causing input values and corresponding output values to be equal for all the input gray-scale values. Meanwhile, any ID smaller than the reference ID denotes that an amount of color-material output is larger than that of the design-basis printer, and thus, is caused to correspond to the correction function lib for making output values smaller than corresponding input values. In this case, any ID much smaller than the reference ID is caused to correspond to the correction function lib for making output values smaller than corresponding input values to a greater degree. Further, any ID larger than the reference ID denotes that an amount of color-material output is smaller than that of the design-basis printer, and thus, is caused to correspond to the correction function lib for making output values larger than corresponding input values. In this case, any ID much larger than the reference ID is caused to correspond to the correction function lib for making output values larger than corresponding input values to a greater degree. In addition, the correction functions lib corresponding to the respective IDs may be non-linear functions, such as gamma curve functions, or linear functions each having an inclination in accordance with the value of the corresponding ID. The computer 10 converts gray-scale values for each color (represented by CMYKLcLm) at the output side, which are defined in the color conversion LUT 11a, by using the correction function 11b, updates the gray-scale values at the output side of the color conversion LUT 11a by the gray-scale values resulting from the conversion, and thereby, corrects the color conversion LUT 11a (in other words, generates the color conversion LUT 11a′). Accordingly, in the above-described example in which the printer 20c has been designated, the computer 10 can generate the color conversion LUT 11a′ corresponding to the second group by correcting the color conversion LUT 11a by using the correction function 11b corresponding to an average value of IDs of the printers 20 belonging to the second group.

The computer 10 performs color conversion of RGB gray-scale values for each of pixels forming the above-described selected image by using a color conversion LUT corresponding to the above-described designated printer 20, and thereby, generates a block of CMYKLcLm data including CMYKLcLm gray-scale values for each pixel. That is, in the case where the printers 20 belonging to the first group have been designated, the above-described selected images are subjected to respective color conversions using the color conversion LUT 11a. Meanwhile, in the case where the printers 20 belonging to the second group have been designated, the above-described selected images are subjected to respective color conversions using the color conversion LUT 11a′ corresponding to the second group. Furthermore, in the case where the printers 20 belonging to the third group have been designated, the above-described selected images are subjected to respective color conversions using the color conversion LUT 11a′ corresponding to the third group. Further, in the case where a plurality of the printers 20 each belonging to a different group have been designated, the above-described selected images are subjected to respective color conversions using the color conversion LUTs (the color conversion LUT 11a and the color conversion LUTs 11a′, or the color conversion LUTs 11a′) corresponding to respective groups to which the designated printers 20 belong.

By performing predetermined halftone processing on the block of CMYKLcLm data resulting from the color conversion, the computer 10 converts the block of CMYKLcLm data into a block of halftone data for each pixel, which specifies on/off of dots corresponding to respective colors of CMYKLcLm, and the like. Further, by performing predetermined rasterizing processing on the blocks of halftone data, the computer 10 generates aggregates of raster data for the respective colors, which result from rearranging the blocks of halftone data in an order, in accordance with which processing is performed by the designated printer 20, and outputs the generated aggregates of raster data to the designated printer 20. Obviously, as described above, in the case where color conversions are performed by using a plurality of color conversion LUTs each corresponding to a different group, the computer 10 performs halftone processing and rasterizing processing on blocks of CMYKLcLm data resulting from each of the color conversions, and outputs aggregates of raster data resulting from the rasterizing processing to each of the designated printers 20 by strictly complying with a correspondence relation between the designated printer 20 and a group corresponding to the color conversion LUT having been used for each of the color conversions. Therefore, the computer 10 certainly outputs data, which has been generated through color conversions using the color conversion LUT 11a, to the printers 20 belonging to the first group. Similarly, the computer 10 outputs data, which has been generated through color conversions using the color conversion LUT 11a′ corresponding to the second group, to the printers 20 belonging to the second group, and outputs, which has been generated through color conversions using the color conversion LUT 11a′ corresponding to the third group, to the printers 20 belonging to the third group.

The designated printers 20 each execute printing on the basis of raster data having been outputted from the computer 10, and reproduce the above-described selected image on predetermined print paper. As described above, in step S140, for each of the above-described groups having been partitioned, the computer 10 corrects the color conversion LUT 11a, which has been generated on the assumption that printing is performed by a design-basis printer, on the basis of a piece of characteristic information (i.e., an average value of IDs) corresponding to the group; performs color conversion of the image by using the color conversion LUT 11a′ resulting from the correction of the color conversion LUT 11a; and thereby, generates print data to be supplied to the respective designated printers 20 belonging to the group.

According to this embodiment, as described above, the computer 10 acquires IDs from the respective plurality of printers 20, which are controllable, via the network N; determines an order for arraying the plurality of printers 20 in accordance with output characteristics of the respective printers 20, which are indicated by the acquired IDs, respectively; and arrays and displays the names of the respective plurality of printers 20 in the order having been determined above in the UI image 41. Accordingly, it is possible for a user who designates the printers 20 upon view of the UI image 41 to, by taking into account the display orders of the respective printers 20, easily perform operations, such as an operation for selecting a plurality of the printers 20 having respective output characteristics closely similar to one another, and an operation for selecting the printers 20 having respective characteristics close to a design basis.

According to this embodiment, the printers 20 each having an ID that is different from a reference ID to a certain degree are supplied with print data, which has been generated by using the LUT 11a′ having been corrected in accordance with an average value of IDs of a group to which the printers 20 belong. Therefore, even if any one of the printers 20 is designated and is caused to perform printing, it is possible to suppress variations among the results of printing due to differences in the output characteristics of the respective printers 20 to a certain degree, and keep a certain degree of image quality. However, in the case where a plurality of the printers 20 are designated, and are caused to perform distributed printing, by designating the printers 20 having respective output characteristics closely similar to one another, or designating the printers 20 having respective output characteristics close to a design basis, it is possible to obtain ideal printing results with less amounts of variations. Therefore, such a configuration as described above in this embodiment, which enables providing users with the UI image 41 that enables the users to easily perform an operation for selecting a plurality of the printers 20 having respective output characteristics closely similar to one another or an operation for selecting the printers 20 having respective output characteristics close to a design basis, is suitable for reduction of amounts of variations among the respective results of the distributed printing performed by the printers 20.

Further, as shown in FIG. 3, by displaying a plurality of the printers 20 having been partitioned into groups each including the printers 20 having respective output characteristics closely similar to one another, it is possible for users to easily recognize individual sets of the printers 20 having respective output characteristics closely similar to one another. Therefore, it is easier for users to designate the printers 20 having respective output characteristics closely similar to one another or designate the printers 20 having respective output characteristics close to a design basis, and thus, it is possible to obtain high-quality printing results in the distributed printing. Furthermore, as shown in FIG. 3, by allocating an initial position of the cursor 41c at a location pointing the printer 20 having an ID representing an output characteristic thereof most close to a design basis (a reference ID), or a group including the above-described printer 20, it is possible for users to, upon view of the UI image 41, instantly recognize which one of the printers 20 or which one of the groups is close to a design basis. Accordingly, it is possible for users, who desire to designate the printer 20 or a group having an output characteristic close to a design basis, to easily designate the printer 20 or a group desired by themselves.

### 3. Modification Example

The invention is not limited to the above-described embodiment, but, can be practiced in various embodiments within the scope not departing from the gist of the invention. Hereinafter, some of modification examples of the invention will be described. The modification examples each can be applied to the above-described embodiment, and can be also combined.

### Modification Example 1

In the UI image 41, the computer 10 may perform switching of two modes in accordance with preset printing conditions, one being a mode for arraying and displaying the printers 20 in an order starting from the printer 20 having the largest amount of color-material output, the other one being a mode for arraying and displaying the printers 20 in an order starting from the printer 20 having the smallest amount of color-material output.

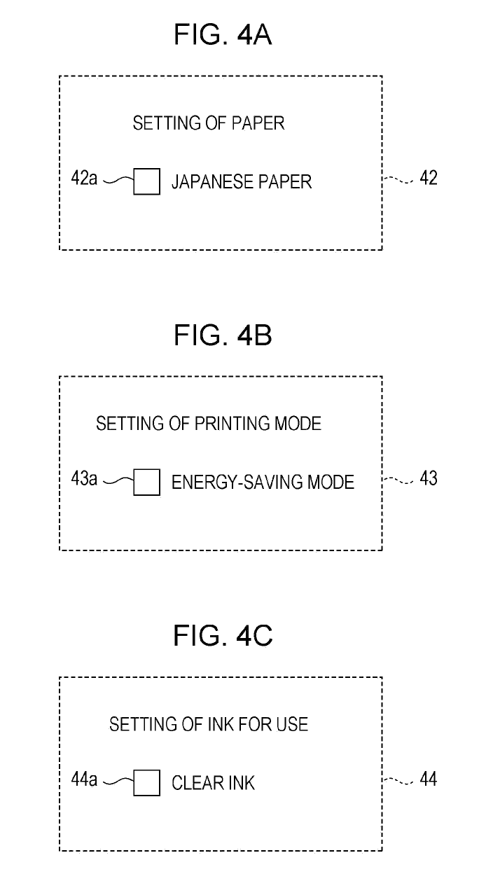

FIGS. 4A, 4B and 4C are diagrams each illustrating an example of a partial scope of a UI image which the computer 10 displays on the display 40 before displaying the UI image 41 by executing the function of the UI display section PD4. FIG. 4A shows an example of a UI image 42, in which users can set print paper to specific print paper (for example, Japanese paper) by performing input into a checkbox 42a. FIG. 4B shows an example of a UI image 43, in which users can set an energy saving mode for suppressing an amount of consumption of ink by performing input into a checkbox 43a. FIG. 4C shows an example of a UI image 44, in which users can set a mode for using a specific kind of ink (for example, clear ink) by performing input into a checkbox 44a.

When using a specific printing medium, such as Japanese paper, a smaller amount of ink for use is preferable because ink is likely to run. Further, as described above, the energy saving mode is a mode for reducing an amount of ink for use. Therefore, when displaying the UI image 41 in step S120, in the case where, via the above-described kinds of UI images, print paper has been set to the above-described specific paper or the energy saving mode has been set, the computer 10 arrays and displays the names of the respective printers 20 in a direction from top to bottom of the image display screen in an order starting from the printer 20 having the smallest amount of color-material output (in an order such as the printer 20f, the printer 20c, the printer 20d, the printer 20b, the printer 20a, the printer 20e). Such a listing display of the printers 20 in an order starting from the printer 20 having the smallest amount of color-material output enables users to easily designate the printers 20 each having a tendency towards a small amount of color-material output. The use of any one of the printers 20 each having a tendency towards a small amount of color-material output corrects an amount of ink for use thereof in an increase direction owing to correction of the above-described color conversion LUT 11a, but still, the amount of ink for use thereof is smaller than that of a design-basis printer. Therefore, as described above, in the case where print paper is set to the above-described specific print paper, or the energy saving mode is set, it makes it easier for users to designate the printers 20 appropriate to printing conditions as of the timing of printing, and thus, is preferable for users to array and display the printers 20 in an order starting from the printer 20 having the smallest amount of color-material output.

Meanwhile, the use of a sufficient amount of a specific kind of ink, such as clear ink, increases gloss of images having been printed on print paper, and thus, is preferable for users. Therefore, when displaying the UI image 41 in step S120, in the case where, via the above-described kinds of UI images, a mode for using the above-described specific kind of ink has been set, the computer 10 arrays and displays the names of the respective printers 20 in a direction from top to bottom of the image display screen in an order starting from the printer 20 having the largest amount of color-material output (in an order such as the printer 20e, the printer 20a, the printer 20b, the printer 20d, the printer 20c, the printer 20f). Such a listing display of the printers 20 in an order starting from the printer 20 having the largest amount of color-material output enables users to easily designate the printers 20 each having a tendency towards a large amount of color-material output. The use of any one of the printers 20 each having a tendency towards a large amount of color-material output corrects an amount of ink for use thereof in a decrease direction owing to correction of the above-described color conversion LUT 11a, but still, the amount of ink for use thereof is larger than that of a design-basis printer. Therefore, as described above, in the case where a mode for using a specific kind of ink has been set, or the like, it makes it easier for users to designate the printers 20 appropriate to printing conditions as of the timing of printing, and thus, is preferable for users to array and display the printers 20 in an order starting from the printer 20 having the largest amount of color-material output. Moreover, in the case where a specific image that is entirely filled with a constant intensity (i.e., a so-called solid image) has been selected, discharging of a slightly large amount of ink is suitable. Therefore, in the case where, as a result of analysis of an image targeted for printing, the computer 10 recognizes that the image targeted for printing is such a specific image as described above, when displaying the UI image 41 in step S120, the computer 10 may array and display the names of the respective printers 20 in a direction from top to bottom of the image display screen in an order starting from the printer 20 having the largest amount of color-material output.

### Modification Example 2

When, from among the plurality of printers 20 having been displayed in the UI image 41, a plurality of the printers 20 having any difference more than or equal to a predetermined number among respective priorities thereof in accordance with the order thereof have been designated in accordance with operations of the operation unit 30 performed by a user, the computer 10 may perform a predetermined warning indication.

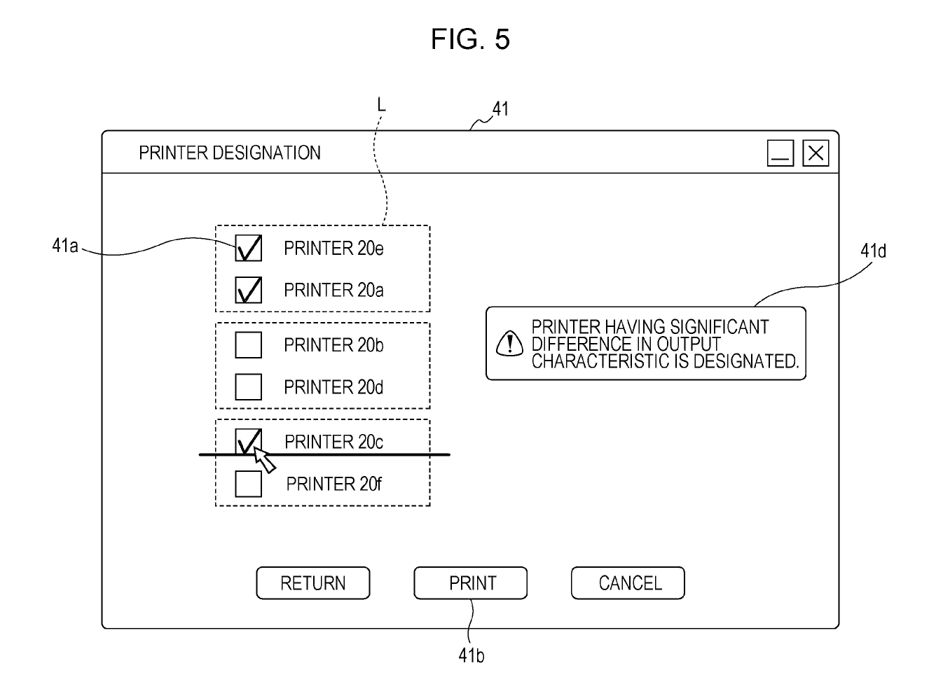

FIG. 5 is a diagram illustrating an example of the UI image 41 including such a warning indication 41d. In this example, the computer 10 performs the warning indication 41d under the situation in which the printer 20 belonging to the second group (i.e., the printer 20c) and the printers 20 belonging to the third group (i.e., the printers 20a and 20e) have been designated. When distributed printing is performed by a plurality of the designated printers 20 having respective output characteristics largely different from one another, even if the above-described color correction LUT 11a is corrected, variations among the results of printing performed by the respective printers 20 are likely to occur. Therefore, by performing the warning indication 41d, it is prevented for users to designate a plurality of the printers 20 having respective output characteristics largely different from one another, and then, issue a print instruction. In addition, there are various determination criteria for determining whether a plurality of the printers 20 having any difference more than or equal to a predetermined number among respective priorities thereof in accordance with the order thereof have been designated, or not. In this embodiment, the computer 10 can determine that a plurality of the printers 20 having any difference more than or equal to a predetermined number among respective priorities thereof in accordance with the order thereof have been designated, in the case where, as described above, in the UI image 41, a plurality of the printers 20 have been designated from each of groups that are not successively arrayed, or a plurality of the printers 20 having any difference more than or equal to a predetermined threshold value among respective IDs thereof have been designated.

What is claimed is:

1. A display control apparatus, comprising:
an acquisition section configured to acquire a piece of characteristic information representing an output characteristic specific to a corresponding printing apparatus from each of a plurality of printing apparatuses; and
a display section configured to determine an order for arraying the plurality of printing apparatuses on the basis of the pieces of characteristic information having been acquired, each being specific to a corresponding printing apparatus, and array and display the plurality of printing apparatuses on a predetermined image display screen in the order having been determined.

2. The display control apparatus according to claim 1, wherein the display section is configured to array and display the plurality of printing apparatuses in an order starting from a printing apparatus having the largest amount of color-material output.

3. The display control apparatus according to claim 1, wherein the display section is configured to array and display the plurality of printing apparatuses in an order starting from a printing apparatus having the smallest amount of color-material output.

4. The display control apparatus according to claim 2, wherein the display section is configured to, in accordance with a preset printing condition, perform switching of two modes, one being a mode for arraying and displaying the plurality of printing apparatuses in an order starting from a printing apparatus having the largest amount of color-material output, the other one being a mode for arraying and displaying the plurality of printing apparatuses in an order starting from a printing apparatus having the smallest amount of color-material output.

5. The display control apparatus according to claim 1, further comprising:
a grouping processing section configured to, by grouping certain ones of the plurality of printing apparatuses, which have respective pieces of characteristic information close to one another, into a group, partition the plurality of printing apparatuses into a plurality of groups, and
wherein the display section is configured to, when arraying and displaying the plurality of printing apparatuses, array and display the printing apparatuses by each of the groups.

6. The display control apparatus according to claim 1, wherein the display section is configured to, when arraying and displaying the plurality of printing apparatuses on an image display screen, display a cursor in addition thereto, which is movable on the image display screen in accordance with an operation from outside, and is used for selecting one or more printing apparatuses from among the plurality of printing apparatuses having been displayed on the image display screen, and allocate an initial position of the cursor at a location where the cursor can select any one of the printing apparatuses, which has the characteristic information most close to a reference value of the characteristic information, or the printing apparatus having the characteristic information most close thereto and partial ones of the printing apparatuses, each of the partial ones thereof having the characteristic information close to that of the printing apparatus having the characteristic information most close thereto.

7. The display control apparatus according to claim 1, wherein the display section is configured to perform a warning indication when a plurality of the printing apparatuses having any difference more than or equal to a predetermined number among respective priorities thereof in accordance with the order thereof have been selected in accordance with an operation from outside from among the plurality of printing apparatuses having been displayed.

8. A display control method, comprising:
acquiring pieces of characteristic information, each representing an output characteristic specific to a corresponding printing apparatus, from a plurality of printing apparatuses;
determining an order for arraying the plurality of printing apparatuses on the basis of the pieces of characteristic information having been acquired, each being specific to a corresponding printing apparatus; and
arraying and displaying the plurality of printing apparatuses on a predetermined image display screen in the order having been determined.
